(19) United States
(12) Patent Application Publication
(10) Pub. No.: US 2006/0261625 A1
(43) Pub. Date: Nov. 23, 2006

(54) Device for fixing a belt lock of a safety belt on a vehicle seat

(76) Inventor: Gregor Kröner, Bischerg (DE)

Correspondence Address: CHRISTIE, PARKER & HALE, LLP, PO BOX 7068, PASADENA, CA, 91109-7068, US

(21) Appl. No.: 10/547,098

(22) PCT Filed: Feb. 13, 2004
(86) PCT No.: PCT/DE04/03000

§ 371 Date: Aug. 26, 2005

(30) Foreign Application Priority Data
Feb. 28, 2003 (DE) 103 10 018.0

(51) Int. Cl. B60N 2/02

(52) U.S. Cl. 296/68.1

(57) ABSTRACT

The invention relates to a device for fixing a belt lock to a vehicle seat comprising a seat underframe which has at least one pivotally mounted crosstube extending crosswise relative to the rail longitudinal guides of a longitudinal adjustment device of the vehicle seat. According to the invention, one locating element is arranged at least in one end area of the crosstube for tying up the belt lock and a device for decoupling or compensating for the movement of the crosstube.

### CROSS-REFERENCE TO A RELATED APPLICATION

This application is a National Phase Patent Application of International Application Number PCT/DE2004/000300, filed on Feb. 13, 2004, which claims priority of German Patent Application Number 103 10 018.0, filed on Feb. 28, 2003.

### BACKGROUND

The invention relates to a device for fixing a belt lock of a safety belt on a vehicle seat.

From U.S. Pat. No. 3,977,725 a longitudinally displaceable vehicle seat is known having a seat underframe which is connected to the floor of the vehicle through a longitudinal adjustment device. The longitudinal adjustment device comprises two longitudinal rail guides with guide rails extending in the longitudinal direction of the seat and displaceable relative to each other in the seat longitudinal direction and of which a bottom rail is connected to the vehicle floor and a top rail guided in the bottom rail is connected to the seat underframe so that adjusting the longitudinal position of the vehicle seat can be carried out by moving the top rail.

The vehicle seat is assigned a belt lock of a safety belt which serves to secure the position of a vehicle occupant sitting on the vehicle seat. The belt lock is on the one hand fixed to a top rail of the longitudinal adjustment device of the vehicle seat so that during longitudinal adjustment of the vehicle seat for comfort reasons the belt lock always retains the same position on the seat underframe. The connection of the belt lock to the top rail of the longitudinal adjustment device is provided by a retaining angle with a fixing point in the rear end region of the seat underframe to which the seat back is attached. In addition the belt lock is fixed on a bolt which is connected to a seat height adjusting mechanism of the vehicle seat so that the belt tension is not changed when adjusting the seat height. However the bolt does not serve to take up the cash forces which act on the vehicle seat or a person seated on the vehicle seat in the event of a crash.

When fixing a belt lock on a longitudinal guide rail for a vehicle seat there is basically the problem that in the event of a crash very severe forces act on the belt lock when a vehicle occupant seated on the seat is restrained by the safety belt assigned to this belt lock. This can lead in particularly serious accidents to either the retaining angle becoming deformed, i.e. stretched so that the belt point is shifted undesirably forwards or the retaining angle becoming detached from the top rail for example by a welded seam which serves to connect the retaining angle to the top rail being sheared off, or the connection between the top rail and bottom rail of the longitudinal rail guide becoming detached which leads to uncontrolled movement of the vehicle seat with the vehicle occupant located thereon.

The problems outlined above can be further increased in that in the event of a short distance between the longitudinal rail guides a correspondingly longer lever is required on the retaining angle in order to produce a connection between the top rail and a side of the vehicle seat. The extended angle of the retaining angle leads with the same crash forces to an increase in the torque acting on the fixing point of the retaining angle on the top rail so that the risk of damage to the connection between the retaining angle and top rail, the risk of the top rail tearing away from the connection with the bottom rail and the risk of the retaining angle stretching are all increased.

The object of the present invention is therefore to provide a device for fixing a belt lock of a safety bolt on a vehicle seat of the type mentioned above which eliminates or at least minimises the risk of a crash-conditioned sharp forward displacement of the belt point or the separation of the connection of the belt lock with the fixing in the vehicle seat without changing the operating comfort.

### BRIEF DESCRIPTION

The solution according to the invention removes or minimises the risk of a crash-conditioned sharp forward displacement of the belt point or of a separation of the connection of the belt lock with the fixing on the vehicle seat without reducing the operating comfort when adjusting the length or height of the vehicle seat since a constant optimum positioning and alignment of the belt lock makes it easier to open and close the safety belt despite the swivel movement of the cross tube.

The solution according to the invention has proved advantageous particularly in the case of longitudinal rail guides having a small gap where the risk of damage to the connection between the belt lock and vehicle seat is particularly great as a result of a long lever arm of the retaining angle.

With the fixing device according to the invention crash-conditioned forces are introduced directly into the cross tube so that no additional connecting or reinforcement means are required which cause the problems mentioned above. Since the cross tube connecting the top rails is designed to take up the crash-conditioned forces and in the event of a crash distributes the strain starting from the safety belt out to both longitudinal rail guides, the risk of the top rail assigned to the belt lock fixing becoming separated from the bottom rail is minimised.

An advantageous development of the solution according to the invention is characterised in that the locator has an adapter connected to the cross tube and provided with an adapter flange for connecting the belt lock.

The adapter can be connected optionally fixed to the cross tube and thus follow a rotational movement of the cross tube or alternatively can be fitted onto the cross tube so that the cross tube engages through an opening in the adapter flange with rotational movement and the alignment of the adapter remains independent of any rotation of the cross tube which may be necessary for example for adjusting the seat height.

The configuration and attachment of the adapter can be provided in different ways. In a first embodiment the adapter is in particular pushed onto the cross tube and connected to a base element of the vehicle seat through a connecting flange. Through these means the adapter retains a predetermined alignment so that additional guide means for aligning the belt lock are not required.

The base element to which the connecting flange is connected for example through a welded joint, can consist for example of a bearing block holding the cross tube and for example connected to the top rail of the longitudinal rail guide, or of a seat side part of the vehicle seat.

Alternatively the adapter can have a bolt insertable in the side end of the cross tube, and an adapter flange for connecting the belt lock.

This configuration of the adapter is then particularly advantageous when the distance between the longitudinal rail guides corresponds roughly to the width of the vehicle seat so that an additional connecting flange can be omitted.

More particularly with a rotationally secured connection of the adapter for connecting the belt lock to a rotatable or pivotal cross tube of in particular a height-adjustable seat underframe, as additional means for uniform alignment of the belt lock can be provided an additional belt lock guide for holding and aligning the belt lock which is preferably connected to a cover panel of the seat side part of the vehicle seat. The belt lock guide can however also be provided in the case of an adapter fitted onto the cross tube wherein the cross tube engages rotationally movable through an opening in the adapter flange and thus the alignment of the adapter is independent of the rotation of the cross tube which may be necessary for example for adjusting the seat height.

The locator according to the invention can be provided on an end region of the cross tube or on both end regions of the cross tube so that the vehicle seat can be used both on the right and left hand side of the vehicle.

The invention will now be explained in further detail with reference to embodiments illustrated in the drawings.

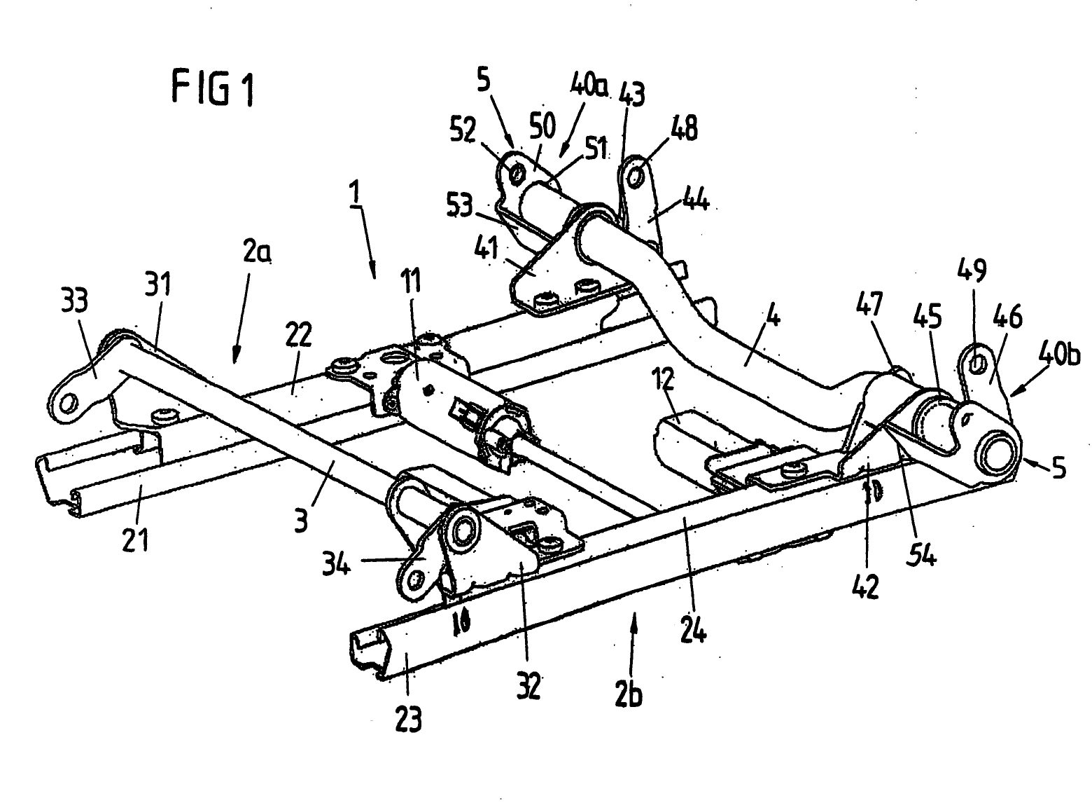

FIG. 1 is a perspective view of a seat underframe with adapters mounted on the end regions of a cross tube;

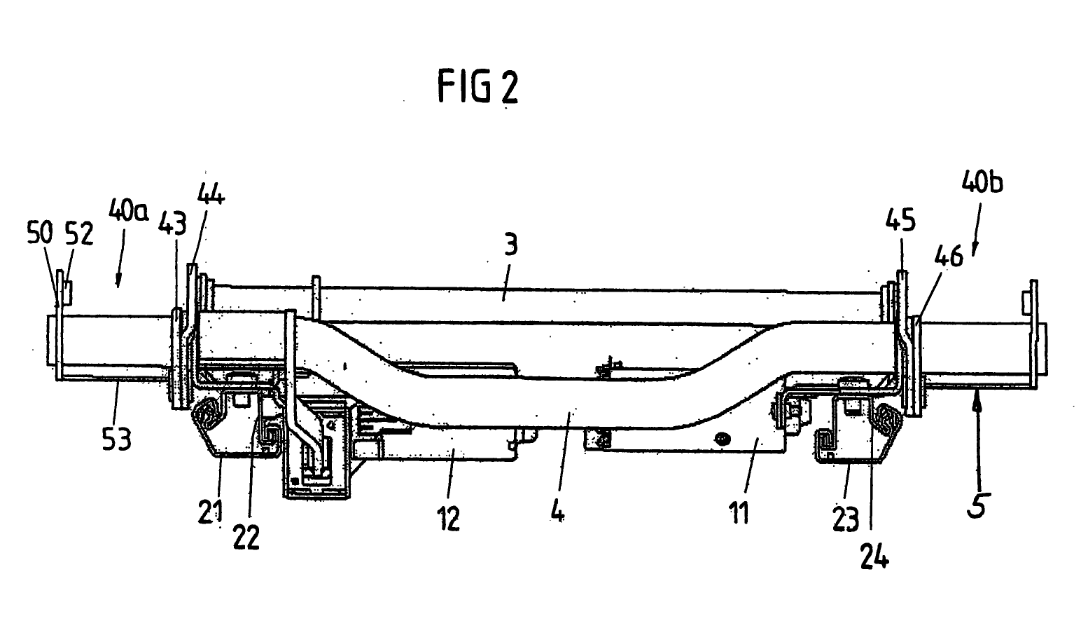

FIG. 2 is a front view of the seat underframe according to FIG. 1;

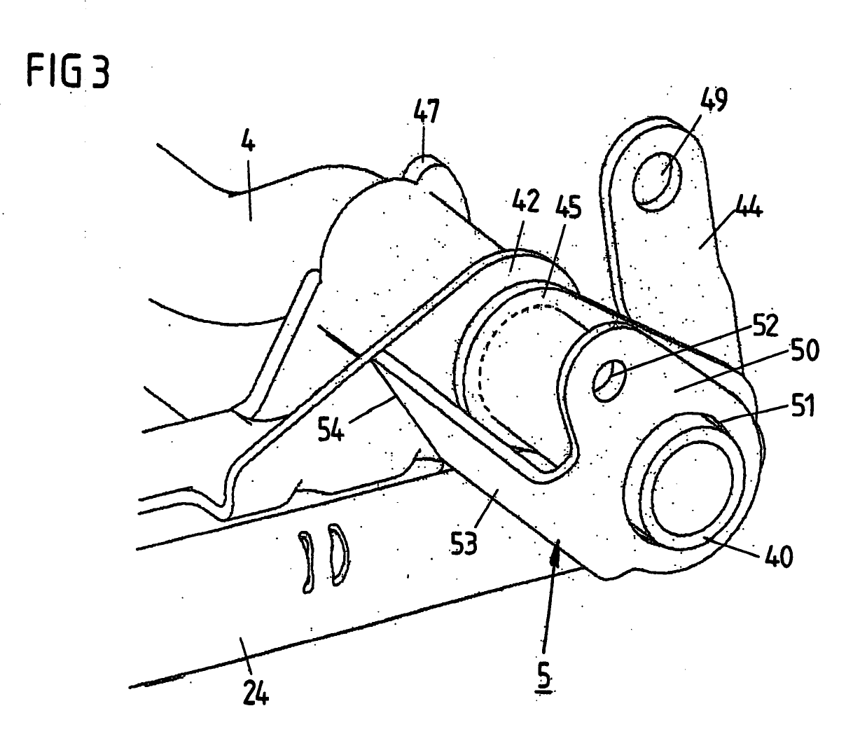

FIG. 3 is an enlarged detailed view of the adapter mounted on the cross tube according to FIGS. 1 and 2 with a fixing of the adapter on a bearing block of the cross tube;

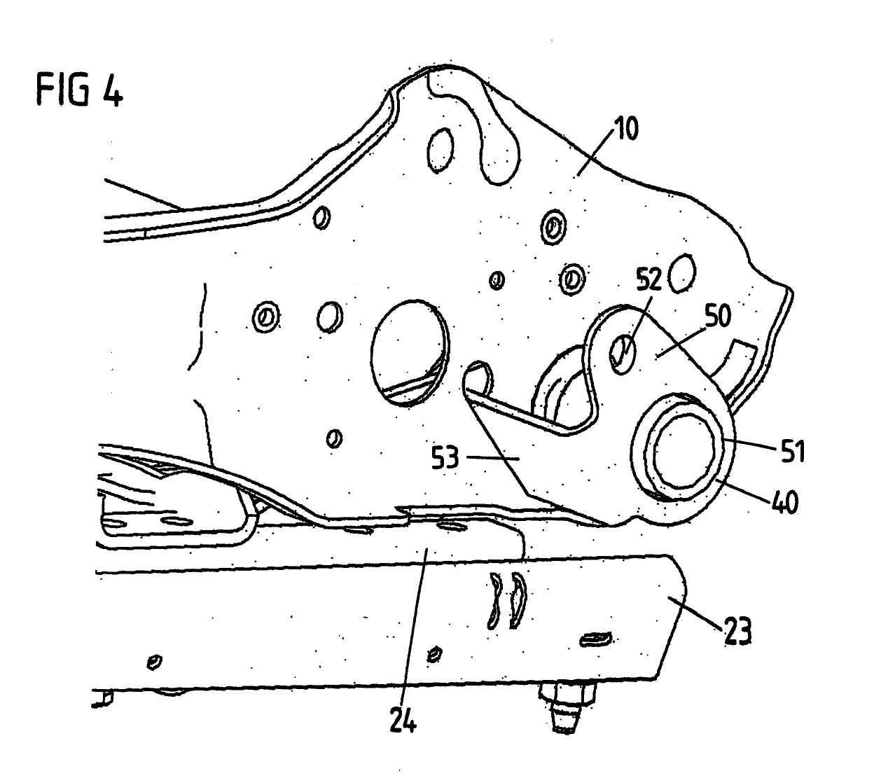

FIG. 4 is an enlarged view of an adapter fixed on a seat side part;

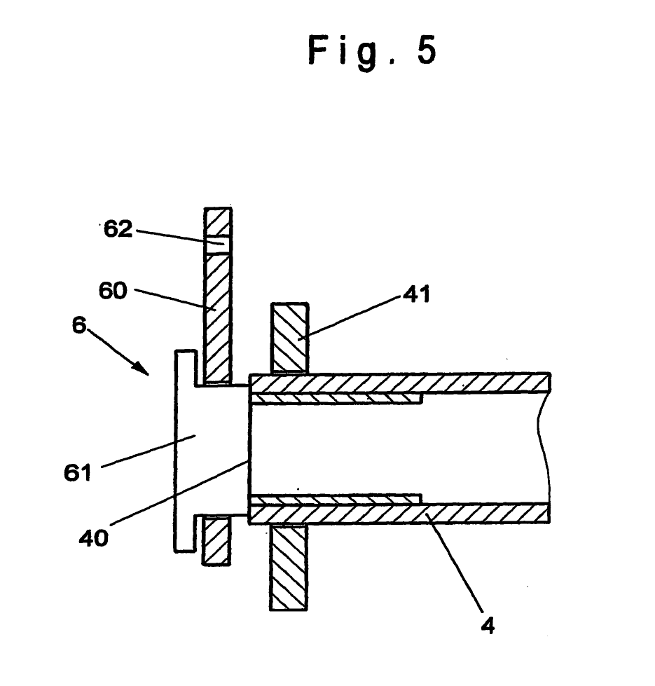

FIG. 5 is a sectional view through an adapter having a stepped bolt and an adapter flange and insertable in the end region of a cross tube; and

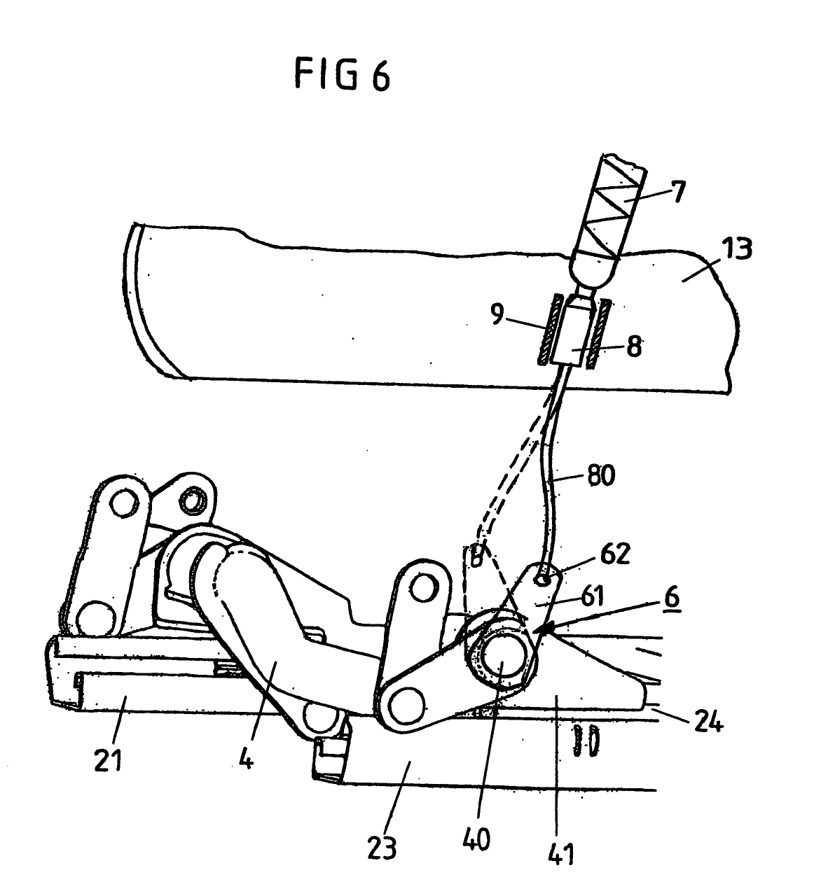

FIG. 6 is a perspective view of an adapter connected rotationally secured to a cross tube and of a belt lock guide fixed on a cover panel of a seat side part.

### DETAILED DESCRIPTION

FIG. 1 shows in a perspective view a seat underframe 1 of a longitudinally adjustable vehicle seat with two longitudinal rail guides 2a and 2b of a longitudinal adjustment device of a vehicle seat each with a bottom rail 21, 23 connected to the vehicle floor in which according to FIG. 2 top rails 22, 24 are guided adjustable in the longitudinal direction.

For the longitudinal adjustment of the vehicle seat an adjusting drive 11 is provided which is connected for example to the top rails 22, 24 and whose shaft engages through pinions at the ends into toothed racks connected to the bottoms rails 21, 23 so that a corresponding seat adjustment takes place by turning the motor shaft of the adjusting drive 11 in one or other rotational direction.

To the front ends of the top rails 22, 24 are connected front bearing blocks 31, 32 which take up a cross bar 3 whose ends are fitted with front pivotal supports 33, 34 for holding the front end of a seat trough of the vehicle seat. The rear ends of the top rails 22, 24 are fitted with rear bearing blocks 41, 42 in which a cross tube 4 is mounted. The cross tube 4 is connected to rear pivotal supports 43, 44 and 45, 46 respectively which can be connected through bores 48, 49 to the rear end of the seat trough of the vehicle seat. The cross tube 4 is furthermore connected to a drive motor 12 through a crank 47 and during actuation of the drive motor 12 is turned in one or other direction so that the rear pivotal supports 43, 44 and 45, 46 are adjusted through the crank 47 and the seat trough of the vehicle seat is raised or lowered to adjust the height of the vehicle seat.

To the end regions 40a, 40b of the cross tube 4 protruding beyond the rear bearing blocks 41, 42 are connected adapters 5 which are comprised of an adapter flange 50 and a connecting flange 53 and have a bore 52 for connecting a belt lock or a belt lash connected at the end to a belt lock. The adapter flange 50 has an opening 51 which can be pushed over the cross tube 4 so that the adapter flange 50 is mounted close to the side end 40 of the cross tube 4. The connecting flange 53 is in this embodiment angled at right angles away from the adapter flange 50 and is connected to the bearing block 41, 42 for example through a welded seam 54.

The opening 51 of the adapter flange 50 is pushed according to the detailed view in FIG. 3 with a tight fit over the cross tube 4 whilst still allowing the cross tube 4 to rotate inside the opening 51. By connecting the adapter 5 to the bearing blocks 41, 42 the connection point for the belt lock in relation to the seat trough or seat side part of the vehicle seat remains constant independently of the height adjustment of the vehicle seat so that no additional measures are required to align the belt lock.

By connecting the adapter 5 directly to the cross tube 4 crash forces acting on the seat belt and thus on the belt lock are introduced directly through the adapter flange 50 and the bore 51 into the cross tube 4 so that no force diversion takes place through a retaining angle or the like. Crash forces emanating from the safety belt are distributed through the bearing blocks 41, 42 to the top rails 22, 24 of the longitudinal rail guides 2a, 2b so that a substantially uniform load distribution takes place over the longitudinal rail guides 2a, 2b of the longitudinal adjustment device.

The detailed view shown in perspective in FIG. 4 shows a connection of the adapter 5 to the seat side part 10 of the vehicle seat wherein the connecting flange 53 of the adapter 5 is connected to the seat side part 10 through a welded joint 54. The construction and function of the adapter 5 corresponds to the construction of the adapter 5 illustrated in FIGS. 1 to 3 and its arrangement on the cross tube 4 and its function so that reference is made to the preceding description.

The length of the connecting flange 53 depends substantially on its connection to a fixing means of the seat underframe, for example the bearing blocks 41, 42 or side part 10 as well as on the distance of the adapter flange 50 from the fixing means. Since the adapter flange 50 owing to the connection and alignment of the belt lock is preferably mounted in the region of the side end 40 of the cross tube 4 the length of the connecting flange 53 depends on the end regions 40a, 40b of the cross tube 4 which project sideways beyond the bearing blocks 41, 42. Where the distance between the longitudinal rail guides 2a, 2b is shorter than the distance between the longitudinal rail guides 2a, 2b shown in FIGS. 1 and 2, the length of the end regions 40a, 40b of the cross tube 4 is correspondingly shortened so that the length of the connecting flanges 53 is also shortened correspondingly.

Whereas with the arrangement shown in FIGS. 1 to 3 owing to the connection of the cross tube 4 to the top rails 22, 24 of the longitudinal rail guides 2a, 2b the adapter 5 is located at a constant height remote from the vehicle floor, with the arrangement according to FIG. 4 it is ensured that the adapter 5 retains a constant position in relation to the seat trough and thus in relation to the seat cushion of the vehicle seat independently of the height adjustment of the vehicle seat since the cross tube 4 is supported in this embodiment on the seat side part 10 and is connected through the pivotal supports to the top rails 22, 24 of the longitudinal rail guides 2a, 2b of the longitudinal adjustment devices.

As an alternative to the structural form of the adapter 5 shown in FIGS. 1 to 4 and its arrangement on the cross tube 4 the adapter flange 50 can also be mounted on the inside of the bearing blocks 41, 42 and a connecting flange can be extended sideways from the adapter flange 50 to connect the belt lock.

A further alternative is illustrated in FIG. 5. The embodiment illustrated in FIG. 5 is particularly suitable for cases where the side end 40 of the cross tube 4 is located directly on the bearing block 41 so that the adapter 5 illustrated in FIGS. 1 to 4 would be mounted by its adapter flange 50 on the side of the bearing block 41 remote from the side end 40 of the cross tube 4.

With the embodiment illustrated in FIG. 5 the adapter 6 consists of a stepped bolt 61 which can be inserted in the side end 40 of the cross tube 4 and which is connected to an adapter flange 60 on which a connection 62 is provided for connecting with the belt lock. The stepped bolt 61 can be inserted for example by a press fit into the side end opening 40 of the cross tube 4 and connected to the cross tube 4 through a screw connection or in any other way whereby it is ensured that crash forces are safely transferred to the cross tube 4.

The connection of the stepped bolt 61 to the adapter flange 60 can be made rotationally secured or rotatable so that during rotation of the cross tube 40 the adapter flange 60 follows the rotation of the cross tube 4 or is aligned constant through a corresponding connection of the adapter flange 60 to a fixing means of the vehicle seat such as shown in FIGS. 1 to 4.

FIG. 6 shows in a diagrammatic perspective view the arrangement of the adapter 6 illustrated in FIG. 5 at the side end of a cross tube 4 which is guided in a bearing block 41 which is connected to the top rail 24 of a longitudinal adjustment device of a vehicle seat. The adapter 6 is connected rotationally secured to the cross tube 4 so that during rotation of the cross tube 4 it changes its alignment and thus the connection point 42 of the adapter flange 61.

FIG. 6 shows the different alignment of the adapter flange 61 and thus the connection point 62 in solid and dotted lines. Since the alignment of the belt lash 80 and thus of the belt lock 8 would change with a change in the connection point 62 on the adapter flange 60 of the adapter 6, but a constant alignment is unacceptable as regards operating comfort, a belt lock guide 9 is provided in which the belt lock 8 is mounted. The belt lock guide 9 is mounted on a cover panel 13 on the seat side part of the vehicle seat. The alignment of the belt lock 8 which is connected through the belt lash 80 to the connecting point 62 of the adapter 6 thereby remains independent of the angular position of the cross tube 4 and thus of the alignment of the adapter 6 whereby during displacement of the cross tube 4 only the upper edge of the belt lock 8 for holding the safety belt 7 changes.

1. A device for fixing a belt lock of a safety belt on a vehicle seat of a vehicle with a seat underframe, the underframe having at least one pivotally mounted cross tube running horizontally in a direction perpendicular to a longitudinal direction of the vehicle, the cross tube forming part of a seat adjusting device,
wherein
an adapter is provided with an adapter flange, the adapter flange connected to the belt lock and holding an end region of the cross tube in rotational movement, the adapter also with a connecting flange fixedly connected to a base element of the vehicle seat.

2. The device according to claim 1, wherein the adapter is held onto the cross tube and the cross tube engages with rotational movement through an opening in the adapter flange.

3. The device according to claim 1 or 2, wherein the base element comprises a bearing block holding the cross tube and is connected to a part of a longitudinal rail guide of the vehicle seat.

4. The device according to claim 1 or 2, wherein the base element consists of a seat side part of the vehicle seat.

5. The device according to claim 8 wherein the cross tube engages rotatably through an opening in the adapter flange.

6. The device according to claim 1, further comprising a belt lock guide for holding the belt lock and connected to a seat side part of the vehicle seat.

7. The device for fixing a belt lock of a safety belt on a vehicle seat of a vehicle with a seat underframe, the underframe having at least one pivotally mounted cross tube running horizontally in a direction perpendicular to a longitudinal direction of the vehicle, the cross tube forming part of a seat adjusting device
wherein
an adapter with an adapter flange is connected rotationally secured to an end region of the cross tube and further comprising a belt lock guide which receives the belt lock.

8. The device according to claim 7, wherein the adapter comprises a bolt which is insertable in a side end of the cross tube.

9. The device according to claim 8, wherein the bolt is a stepped bolt.

10. The device according to claim 7, wherein the belt lock guide is connected to a cover panel of a seat side part of the vehicle seat.

11. The device according to claim 7, wherein the adapter is connected to both end regions of the cross tube.
